(19) United States
(12) Patent Application Publication
(10) Pub. No.: US 2005/0158419 A1
(43) Pub. Date: Jul. 21, 2005

(54) Thermal processing system for imprint lithography

(76) Inventors: Michael P.C. Watts, Austin, TX (US); Byung-Jin Choi, Round Rock, TX (US); Frank Y. Xu, Austin, TX (US)

Correspondence Address: MOLECULAR IMPRINTS, INC.;KENNETH C. BROOKS, PO BOX 81536, AUSTIN, TX, 78708-1536, US

(21) Appl. No.: 10/758,384

(22) Filed: Jan. 15, 2004

(51) Int. Cl. B05B 5/00; B29C 35/10

(52) U.S. Cl. 425/174.4; 118/641; 118/46

(57) ABSTRACT

The present invention is a system that selectively directs radiation of multiple wavelengths at a substrate to facilitate pattern formation. The system may include a wavelength discriminator to filter the radiation and an absorption layer to develop a localized heat source. The localized heat source may be employed to raise a temperature of an imprinting layer. This improves the flow rate and the fill factor of the material disposed within the imprinting layer, thus reducing the time required to fill the features defined on a mold.

### BACKGROUND OF THE INVENTION

The field of the invention relates generally to imprint lithography. More particularly, the present invention is directed to a patterning system that produces and selectively directs infrared radiation at a substrate to develop a localized heat source.

Micro-fabrication involves the fabrication of very small structures, e.g., having features on the order of micro-meters or smaller. One area in which micro-fabrication has had a sizeable impact is in the processing of integrated circuits. As the semiconductor processing industry continues to strive for larger production yields while increasing the circuits per unit area formed on a substrate, micro-fabrication becomes increasingly important. Micro-fabrication provides greater process control while allowing increased reduction of the minimum feature dimension of the structures formed. Other areas of development in which micro-fabrication has been employed include biotechnology, optical technology, mechanical systems and the like.

An imprint lithography technique is disclosed by Chou et al. in Ultrafast and Direct Imprint of Nanostructures in Silicon, Nature, Col. 417, pp. 835-837, June 2002, which is referred to as a laser assisted direct imprinting (LADI) process. In this process a region of a substrate is made flowable, e.g., liquefied, by heating the region with the laser. After the region has reached a desired viscosity, a mold, having a pattern thereon, is placed in contact with the region. The flowable region conforms to the profile of the pattern and is then cooled, solidifying the pattern into the substrate.

An exemplary micro-fabrication technique is shown in U.S. Pat. No. 6,334,960 to Willson et al. Willson et al. discloses a method of forming a relief image in a structure. The method includes providing a substrate having a transfer layer. The transfer layer is covered with a polymerizable fluid composition. A mold makes mechanical contact with the polymerizable fluid. The mold includes a relief structure, and the polymerizable fluid composition fills the relief structure. The polymerizable fluid composition is then subjected to conditions to solidify and to polymerize the same, forming a solidified polymeric material on the transfer layer that contains a relief structure complimentary to that of the mold. The mold is then separated from the solid polymeric material such that a replica of the relief structure in the mold is formed in the solidified polymeric material. The transfer layer and the solidified polymeric material are subjected to an environment to selectively etch the transfer layer relative to the solidified polymeric material such that a relief image is formed in the transfer layer. The time required by this technique is dependent upon, inter alia, the time the polymerizable material takes to fill the relief structure.

Thus, there is a need to provide an improved system for the filling of the relief structure with the polymerizable material.

### SUMMARY OF THE INVENTION

The present invention is a system that selectively directs radiation of multiple wavelengths at a substrate to facilitate pattern formation. The system may include a wavelength discriminator to filter the radiation and an absorption layer to develop a localized heat source. The localized heat source may be employed to raise a temperature of an imprinting layer. This improves a flow rate and a fill factor of the material disposed within the imprinting layer, thus reducing the time required to fill the features defined on a mold.

### BRIEF DESCRIPTION OF THE DRAWINGS

FIG. 1 is a perspective view of a lithographic system in accordance with the present invention;

FIG. 2 is a simplified elevation view of a lithographic system shown in FIG. 1;

FIG. 3 is a simplified representation of material from which a thin film layer, shown in FIG. 2, is comprised before being polymerized and cross-linked;

FIG. 4 is a simplified representation of cross-linked polymer material into which the material shown in FIG. 3 is transformed after being subjected to radiation;

FIG. 5 is a simplified elevation view of a mold spaced-apart from the thin film layer, shown in FIG. 1, after patterning of the thin film layer;

FIG. 6A is a side view of an absorption layer disposed between a wafer and wafer chuck;

FIG. 6B is a side view of an absorption layer disposed between an imprinting layer and a wafer;

FIG. 7 is a side view of a simplified lithographic system depicting dual radiation sources;

FIG. 8 is a detailed view of a wafer having imprinting material disposed thereon shown in FIG. 7;

FIG. 9 is a side view of a simplified lithographic system depicting a single radiation source;

FIG. 10. is a detailed view of a wafer having imprinting material disposed thereon shown in FIG. 9; and

FIG. 11 is a flow diagram showing the method of increasing a flow rate of imprinting material in accordance with the present invention.

### DETAILED DESCRIPTION OF THE INVENTION

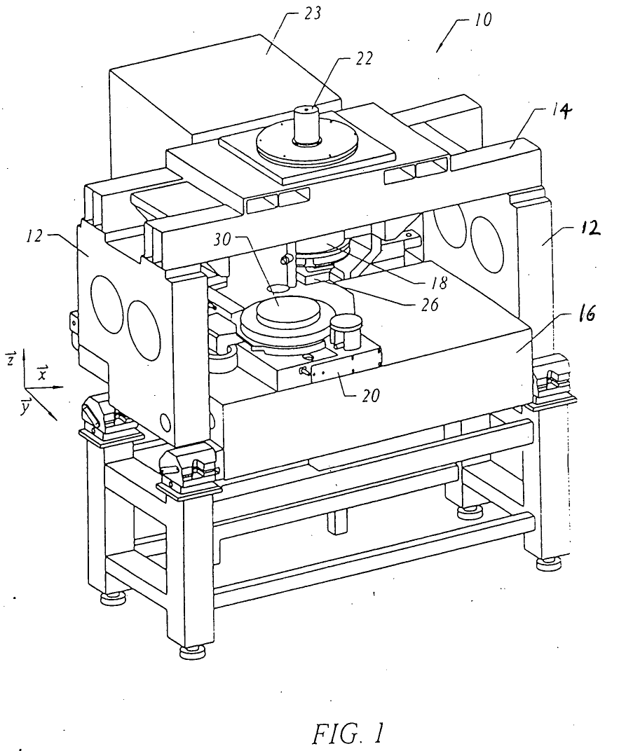

FIG. 1 depicts a lithographic system 10 that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16. Disposed upon stage support 16 to face imprint head 18 is a motion stage 20. Motion stage 20 is configured to move with respect to stage support 16 along X- and Y-axes. A radiation system 22 is coupled to lithographic system 10 to impinge radiation upon wafer 30. As shown, radiation system 22 is coupled to bridge 14 and includes a power generator 23 connected to radiation system 22.

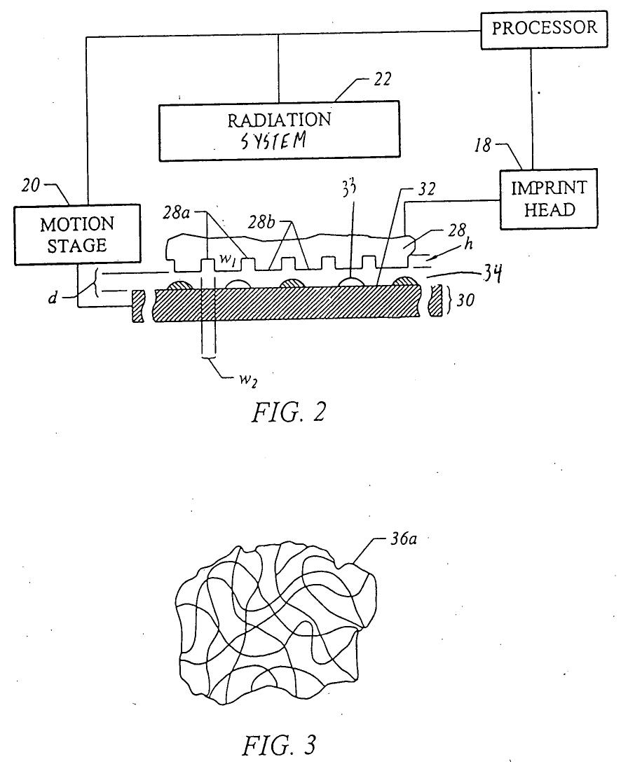

Referring to both FIGS. 1 and 2, connected to imprint head 18 is a substrate 26 having a mold 28 thereon. Mold 28 includes a plurality of features defined by a plurality of spaced-apart recessions 28a and protrusions 28b, having a step height, h, on the order of nanometers, e.g., 100 nanometers. The plurality of features defines an original pattern that is to be transferred into a wafer 30 positioned on motion stage 20. To that end, imprint head 18 is adapted to move along the Z axis and vary a distance “d” between mold 28 and wafer 30. In this manner, the features on mold 28 may be imprinted into a flowable region of wafer 30, discussed more fully below. Radiation system 22 is located so that mold 28 is positioned between radiation system 22 and wafer 30. As a result, mold 28 is fabricated from material that allows it to be substantially transparent to the radiation produced by radiation system 22.

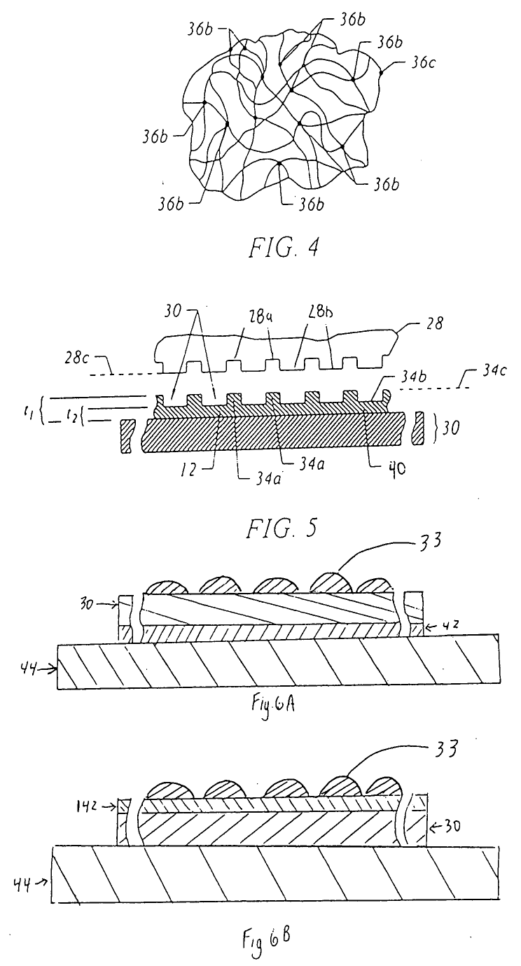

Referring to both FIGS. 2 and 3, a flowable region is disposed on a portion of surface 32 that presents a substantially planar profile. In the present embodiment, however, the flowable region consists of a plurality of spaced-apart discrete droplets 33 of material 36a on wafer 30, defining a flowable imprinting layer 34. Imprinting layer 34 is formed from a material 36a that may be selectively polymerized and cross-linked to record the original pattern therein, defining a recorded pattern. Material 36a is shown in FIG. 4 as being cross-linked at points 36b, forming cross-linked polymer material 36c.

Referring to FIGS. 2, 3 and 5, the pattern recorded by imprinting layer 34 is produced, in part, by mechanical contact with mold 28. To that end, imprint head 18 reduces the distance “d” to allow imprinting layer 34 to come into mechanical contact with mold 28, spreading droplets 33 so as to form imprinting layer 34 with a contiguous formation of material 36a over surface 32. In one embodiment, distance “d” is reduced to allow sub-portions 34a of imprinting layer 34 to ingress into and fill recessions 28a.

In the present embodiment, sub-portions 34b of imprinting layer 34 in superimposition with protrusions 28b remain after the desired, usually minimum distance “d”, has been reached, leaving sub-portions 34a with a thickness t₁, and sub-portions 34b with a thickness t₂. Thicknesses “t₁” and “t₂” may be any thickness desired, dependent upon the application.

Referring to FIGS. 2, 4, and 5, after a desired distance “d” has been reached, radiation system 22 produces actinic radiation that polymerizes and cross-links material 36a, shown in FIG. 3, forming cross-linked polymer material 36c. As a result, the composition of imprinting layer 34 transforms from material 36a, shown in FIG. 3, to cross-linked polymer material 36c, which is a solid, forming solidified imprinting layer 40. Specifically, cross-linked polymer material 36c is solidified to provide side 34c of imprinting layer 40 with a shape conforming to a shape of a surface 28c of mold 28, thereby recording the pattern of mold 28 therein. After formation of imprinting layer 40, imprint head 18 is moved to increase distance “d” so that mold 28 and imprinting layer 40 are spaced-apart.

Referring to FIGS. 3 and 5, as the features defined on mold 28 become substantially smaller, i.e., recessions 28a and protrusions 28b, the time required to fill recessions 28a with material 36a increases, which is undesirable. Therefore, to reduce the time required to fill recessions 28a, it is desirable to increase the flow rate of material 36a. One manner in which to increase the flow rate of material 36a is to lower the viscosity of the same. To that end, the temperature of material 36a may be changed to be above the glass transition temperature associated therewith. Typically, material 36a is not increased to a temperature above 120° C.

Referring to FIGS. 3 and 6A, to increase a flow rate of material 36a in an imprint lithography process, infrared (IR) radiation is utilized. However, material 36a, and hence droplets 33, are substantially transparent to IR radiation; and thus, heating the same by exposure to IR radiation is problematic. Therefore, an absorption layer 42, which is responsive to IR radiation is utilized. Absorption layer 42 comprises a material that is excited when exposed to IR radiation and produces a localized heat source. Typically, absorption layer 42 is formed from a material that maintains a constant phase state during the heating process which may include a solid phase state. Specifically, the IR radiation impinging upon absorption layer 42 causes an excitation of the molecules contained therein, generating heat. The heat generated in absorption layer 42 is transferred to material 36a in droplets 33 via heat conduction through wafer 30. Thus, material 36a in droplets 33 may be heated at a sufficient rate to lower the viscosity of the same, thereby increasing the flow rate. As a result, absorption layer 42 and wafer 30 provide a bifurcated heat transfer mechanism that is able to absorb IR radiation and to produce a localized heat source sensed by droplets 33 to transmit heat through heat conduction. Absorption layer 42 may be permanently or removably attached. Exemplary materials that may be employed as absorption layer 42 include black nickel and anodized black aluminum. Also, black chromium may be employed as absorption layer. Black chromium is typically deposited as a mixture of oxides and is used coating of solar cells.

Referring to FIG. 6B, in another embodiment absorption layer 142 may be disposed between droplets 33 and wafer 30. In this manner, absorption layer 142 creates a localized heat sources in surface 142a. To that end, absorption layer 142 may be deposited using any known technique, including spin-on, chemical vapor deposition, physical vapor deposition and the like. Exemplary materials that may be formed from a carbon based PVD coating, organic thermo set coating with carbon black filler or molybdenum disulfide (MoS₂) based coating.

Referring to FIGS. 3, 5, and 6A, increasing the temperature of material 36a may be problematic due to, inter alia, evaporative loss. To reduce, if not avoid, evaporative loss of material 36a in droplets 33, IR radiation may be impinged upon absorption layer 42 when mold 28 is in close proximity to droplets 33. As a result of mold 28 and droplets 33 being in close proximity, the atmosphere between mold 28 and droplets 33 is reduced, thereby reducing a rate of evaporative loss of droplets 33. Further, any evaporative losses of material 36a will most likely collect on mold 28, thereby preventing loss of material 36a. In a further embodiment, the atmosphere between droplets 33 and mold 28 may be reduced by partial or whole evacuation, further lessening evaporative loss of material 36a in droplets 33.

A second method of reducing the rate of evaporative loss of droplets 33 is to heat mold 28, wherein the temperature of mold 28 is raised to a temperature greater than the temperature of wafer 30. As a result, a thermal gradient is created in an atmosphere between template 28 and wafer 30. This is believed to reduce the evaporative loss of material 36a in droplets 33.

Referring to FIGS. 3 and 5, after lowering the viscosity of material 36a and contacting the same with mold 28, polymerization and cross-linking of material 36a may occur, as described above. Material 36a, as mentioned above, comprises an initiator to ultraviolet (UV) radiation to polymerize material 36a thereto in response.

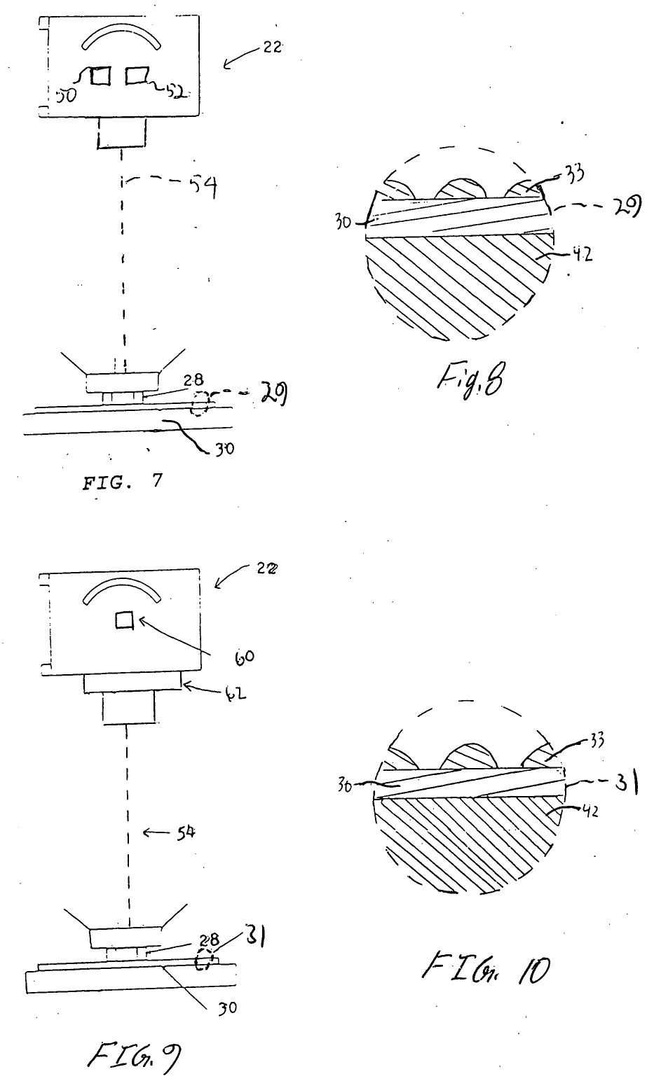

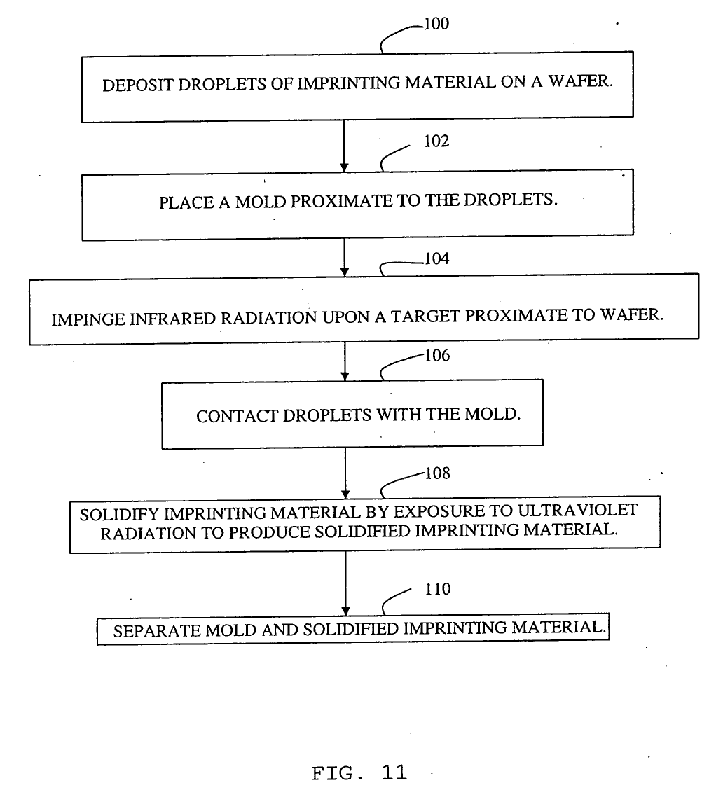

Referring to FIGS. 1 and 7, to that that end, one embodiment of radiation system 22 includes dual radiation sources, i.e., radiation source 50 and radiation source 52. For example, radiation source 50 may be any known in the art capable of producing IR radiation. Radiation source 52 may be any known in the art capable of producing actinic radiation employed to polymerize and cross-link material in droplets 33, such as UV radiation. Specifically, radiation produced by either of sources 50 and 52 propagates along optical path 54 toward wafer 30. Typically, mold is disposed in optical path 54 and as a result, is transmissive to both UV and IR radiation. A circuit (not shown) is in electrical communication with radiation sources 50 and 52 to selectively allow radiation in the UV and IR spectra to impinge upon wafer 30. In this fashion, the circuit (not shown) causes radiation source 50 to produce IR radiation when heating of material, shown in FIG. 3, is desired and the circuit (not shown) causes radiation source 52, shown in FIG. 7, to produce UV radiation when polymerization and cross-linking of material, shown in FIG. 3, is desired. It is possible to employ the requisite composition of material 36a to allow cross-linking employing IR alone or in conjunction with UV radiation. As a result, material 36a would have to be heated with sufficient energy to facilitate IR cross-linking An exemplary material could include styrene divinylbenzene, both available from Aldrich Chemical Company, Inc. located at 1001 West Saint Paul Avenue, Milwaukee, Wis. and Irgacure 184 or 819 available from Ciba Specialty Chemicals, at 560 White Plains Road, Tarrytown, N.Y. 10591. The combination consists of, by weight, 75-85 parts styrene, with-80 parts being desired, 15-25 parts divinylbenzene, with 20 parts being desired, 1-7 parts Iragure, with 4 parts being desired, with the remaining portion of the composition comprising stabilizers to ensure suitable shelf-life.

Referring to FIG. 8, in another embodiment, radiation system 22 consists of a single broad spectrum radiation source 60 that produces UV and IR radiation. An exemplary radiation source 60 is a mercury (Hg) lamp. To selectively impinge differing types of radiation upon wafer 30, a filtering system 62 is utilized. Filtering system 62 comprises a highpass filter (not shown) and a lowpass filter (not shown), each in optical communication with radiation source 60. Filtering system 62 may position highpass filter (not shown) such that optical path 54 comprises IR radiation or filtering system 62 may position lowpass filter (not shown) such that optical path 54 comprises UV radiation. Highpass and lowpass filters (not shown) may be any known in the art, such as interference filters comprising two semi-reflective coatings with a spacer disposed therebetween. The index of refraction and the thickness of the spacer determine the frequency band being selected and transmitted through the interference filter. Therefore, the appropriate index of refraction and thickness of the spacer is chosen for both the highpass filter (not shown) and the lowpass filter (not shown), such that the highpass filter (not shown) permits passage of IR radiation and the lowpass filter (not shown) permits passage of UV radiation. A processor (not shown) is in data communication with radiation source 60 and filtering system 62 to selectively allow the desired wavelength of radiation to propagate along optical path 54. The circuit enables highpass filter (not shown) when IR radiation is desired and enables the lowpass filter (not shown) when UV radiation is desired.

Referring to FIGS. 3, 4, 6A and 11, in operation, imprinting material is deposited on wafer 30 at step 100. Thereafter, at step 102, mold 28 is placed proximate to droplets 33. Following placing mold 28 proximate to droplets, IR radiation in impinged upon a target, which in the present case is the thermal absorption layer 42. Typically, the temperature of material 36a in droplets is increased to provide a desired flow rate. This may be above a glass transition temperature associated with material 36a. After material 36a has been heated to a desired temperature, contact is made between mold 28 and droplets 33 at step 104. In this manner, material 36a is spread over wafer 30 and conforms to a profile of mold 28. At step 106, material 36a is transformed into material 36c by exposing the same to actinic radiation, e.g. UV radiation, to form imprinting layer 40. If cooling of material 34a is desired, this may be accomplished through any method known in the art, such as natural convection/conduction through the wafer chuck or enforced convection/conduction with nitrogen (N₂) gas or a chilled substrate chuck. Further, cooling may occur before or after solidification of material 36a. Thereafter mold 28 and imprinting layer 40 are spaced-apart at step 108, and subsequent processing occurs at step 110.

While this invention has been described with references to various illustrative embodiments, the description is not intended to be construed in a limiting sense. For example, heating is described as occurring after the mold is placed proximate to droplets. However, heating may occur before the mold is placed proximate to the droplets. As a result various modifications and combinations of the illustrative embodiments, as well as other embodiments of the invention, will be apparent to persons skilled in the art upon reference to the description. It is, therefore, intended that the appended claims encompass any such modifications or embodiments.

1. A patterning system comprising:
a bifurcated heat transfer mechanism having a surface; and
a source of radiation to direct thermal radiation toward said bifurcated heat transfer mechanism, with said bifurcated heat transfer mechanism collecting said thermal radiation and conducting said thermal radiation to said surface.

2. The system as recited in claim 1 wherein said bifurcated heat transfer mechanism further includes developing a localized heat source proximate to said surface.

3. The system as recited in claim 1 wherein said system further includes a mold positioned between said bifurcated heat transfer mechanism and said source of radiation to allow said radiation to propagate there through.

4. The system as recited in claim 1 wherein said system further includes an imprinting layer positioned between said bifurcated heat transfer mechanism and said source of radiation to allow said thermal radiation to propagate there through.

5. The system as recited in claim 1 wherein said bifurcated heat transfer mechanism comprises a carbon black composition.

6. The system as recited in claim 1 wherein said bifurcated heat transfer mechanism is permanently disposed within said system.

7. The system as recited in claim 1 wherein said bifurcated heat transfer mechanism is removably disposed within said system.

8. A patterning system comprising:
a source of radiation to direct radiation toward a target;
a wavelength discriminator to selectively allow first and second subsets of said radiation to reach said target, with said first subset including thermal energy; and
a mold positioned to allow said first and second subsets to propagate there through; and
a thermal absorption layer disposed to collect said first subset and to develop a localized heat source therein, with said heat source maintaining a constant phase state.

9. The system as recited in claim 8 wherein said system further includes an imprinting layer positioned between said mold and said thermal absorption layer to allow said first subset to propagate there through.

10. The system as recited in claim 8 wherein said thermal absorption layer comprises a carbon black composition.

11. The system as recited in claim 8 wherein said thermal absorption layer is permanently disposed within said system.

12. The system as recited in claim 8 wherein said thermal absorption layer is removably disposed within said system.

13. The system as recited in claim 8 wherein said constant phase state comprises a solid phase state.

14. A patterning system comprising:
a source of radiation to direct radiation, having multiple wavelengths including thermal radiation, along a path, with said path extending between said source and a target;
a wavelength discriminator to selectively allow a subset of said radiation to travel toward said target; and
a bifurcated heat transfer mechanism having a surface disposed between said wavelength discriminator and said target to collect said thermal radiation and to develop heat energy therein, and to conductively transfer said heat energy from said thermal absorption layer to said surface.

15. The system as recited in claim 14 wherein said system further includes a mold positioned between said bifurcated heat transfer mechanism and said source of radiation to allow said radiation to propagate there through.

16. The system as recited in claim 14 wherein said system further includes an imprinting layer positioned between said bifurcated heat transfer mechanism and said source of radiation to allow said thermal radiation to propagate there through.

17. The system as recited in claim 14 wherein said bifurcated heat transfer mechanism comprises a carbon black composition.

18. The system as recited in claim 14 wherein said bifurcated heat transfer mechanism is permanently disposed within said system.

19. The system as recited in claim 14 wherein said bifurcated heat transfer mechanism is removably disposed within said system.
